(19) United States
(12) Patent Application Publication
(10) Pub. No.: US 2018/0285528 A1
(43) Pub. Date: Oct. 4, 2018

(54) SENSOR ASSISTED MENTAL HEALTH THERAPY

(71) Applicant: Intel Corporation, Santa Clara, CA (US)

(72) Inventors: Jennifer Anne Healey, San Jose, CA (US); Lama Nachman, San Francisco, CA (US); Sangita Ravi Sharma, Portland, OR (US); Giuseppe Raffa, Portland, OR (US)

(21) Appl. No.: 15/474,421

(22) Filed: Mar. 30, 2017

(51) Int. Cl. G06F 19/00; H04L 29/08; H04L 12/24; G06N 99/00

(52) U.S. Cl. CPC G06F 19/345; G06N 99/005; H04L 41/22; H04L 67/12

(57) ABSTRACT

Computer systems to allow users to record sensor readings of their environment and correlate these sensor readings with mental health events for later analysis to improve mental health diagnoses and treatments. A monitoring system comprising a computing device and a sensor set (comprising one or more sensors integral to or communicatively coupled to the computing device) may collect and store data collected about the user. This data may be stored in the computing device, or may be stored in a cloud based data-storage service. This data may be annotated or correlated (either manually, or automatically) with mental health events of the user and used for later analysis.

### TECHNICAL FIELD

Embodiments pertain to using sensor data of a user to augment psychiatric and other mental health therapy. Some embodiments pertain to recording sensor readings of a person's environment and then correlating these sensor readings with mental health events for later analysis.

### BACKGROUND

In mental health, the current best practice is for people to remember their experiences themselves and keep track of these manually. Current solutions employ journals, diaries, or rely upon the patient's memory. These solutions require time and patience and are difficult to implement in a busy lifestyle.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of a mental health system according to some examples of the present disclosure.

FIG. 2 is a flow diagram of the operation of the mental health system according to some examples of the present disclosure.

FIG. 3 shows an example modeler according to some examples of the present disclosure.

FIG. 4 is a flowchart of a method of determining mental health events is shown according to some examples of the present disclosure.

FIG. 5 is a block diagram illustrating an example of a machine upon which one or more embodiments may be implemented.

### DETAILED DESCRIPTION

Many severe emotional episodes may be considered easy to remember, but human memory is fallible in many ways. For example, it is often difficult for people to remember the exact time of day of an event. Additionally, the exact details of an event may become warped or changed in memory. Not only is it difficult to remember the exact details but also memories are based upon biased perceptions and may change over time. Manual methods of recording events for later therapy are time consuming and subject to these biases.

Disclosed in some examples are methods, systems, computing devices, and machine-readable mediums which allow users to record sensor readings of their environment and correlate these sensor readings with mental health events for later analysis. In some examples, a monitoring system comprising a computing device and a sensor set (comprising one or more sensors integral to or communicatively coupled to the computing device) may collect and store data collected about the user. This data may be stored in the computing device, or may be stored in a cloud based data-storage service. This data may be annotated or correlated (either manually or automatically) with mental health events of the user and used for later analysis. Mental health events are emotional responses that the system is configured to monitor for. Mental health events may be emotions—such as fear, happiness, anxiety, depression, and the like, but also may be defined more granularly such as emotions caused by the occurrence of one or more events. For example, fear caused by a dog barking.

In some examples, all sensor data collected by the sensor set may be stored, but in other examples, only sensor data in temporal proximity (e.g., a predetermined threshold before and after) of a mental health event may be stored. Storing at least a subset of all sensor set data (not just proximate a mental health event) for longer term monitoring (e.g., at a low level of detail) may be utilized to from a better understanding of what “normal” is for a user.

In still other examples, the system may store a subset of the sensor data normally, but then store a larger subset of the data in temporal proximity of a mental health event or other triggering event. For example if the system heard a dog barking and a dog barking triggers a mental health event, the system could increase audio fidelity, decide to additionally record raw audio, gather data from nearby cameras if allowable, collect data about the location (e.g. all stores/buildings near the current GPS), or for example switch from recording only still images to recording full video during the mental health event. Other triggering events include a user input indicating a preference for recording more data (e.g., the user may determine that a particularly stressful situation may be coming soon), the presence of a particular person (e.g., based upon voice recognition), a scheduled event, or the like.

In some examples the sensor data may be analyzed or enhanced by utilizing voice detection and speaker identification, facial recognition, emotion detection (e.g., from facial recognition data), speech-to-text, and the like. In some examples, the data may be compressed and/or anonymized. For example, the data may be compressed by storing features extracted from the data (e.g., emotional states such as “angry” rather than the data concluding that anger is expressed). Other example features include a Mel Frequency Cepstral Coefficient (MFCC). The system may determine when a mental health event is occurring based upon a signal from the user, based upon an analysis of sensor readings detected by the computing device, or the like. The user may provide a simple button press that indicates a mental health event, or may have more complex inputs that may label the data with labels such as “stress,” “anger,” “depression,” panic,” or include an indication of a craving for an undesired item such as a cigarette or alcohol. The user may include her own (potentially biased) judgment of why an incident happened, i.e. “dog barking”, or “meeting with person X”. This information could potentially help the therapist understanding the perception of the person affected by the event.

The computing device may also automatically detect the mental health event based upon the sensor data collected. This automatic detection may supplement the user's manual indications or may replace them. For example, a rule may specify values of one or more sensors that indicate the presence of a mental health event. For example, a physiological sensor may exceed a threshold or exhibit a particular predetermined behavior. For example, a rule may specify a pattern of heart rates that indicates stress or anxiety. As another example, the presence of a particular voice in audio sensor data (e.g., an individual that stresses the user out), a particular noise threshold, a detected face in video data (e.g., an individual that stresses the user out), or the like. Multiple sensor values may be utilized to detect the mental health event. For example, an elevated heart rate in combination with detecting a dog barking may signal an event. For example, complex rules may be programmed into the computing device whereby multiple sensor readings may be utilized such as: if <sensor 1>detects <pattern>AND/OR <sensor 2>detects <pattern 2>AND/OR . . . . Thus complex if-then rules (e.g., decision trees) may be utilized.

In other examples, the system may utilize one or more past sensor values labelled by the user or a mental health professional as training data to a machine learning model that may be used to analyze live sensor data to determine mental health events.

This data may then be logged and shared with the user or their mental health professional for the purpose of enhancing their therapy. Moreover, the system may detect certain mental health events and take one or more assistive actions. For example, a message may be delivered to the user to take corrective or ameliorative actions such as taking a different route (if traffic is the stress), doing breathing or other stress relief exercises, calling a therapist (automatically or with approval after suggesting it), calling a friend or other helper, or the like.

This system allows people to collect and use data in the moment to improve their mental health, especially in conjunction with a therapist. As noted most current mental health therapy relies on people recounting their remembered experiences to a therapist. The therapist then tries to piece together insights from both the facts of the person's story and how they describe it. Based on the person's previous therapy sessions, the therapist may also notice a pattern triggering certain emotional responses from the person and inferring a pattern. This system captures emotionally salient experiential information and brings this information into the therapeutic process removing the involuntary but inevitable bias introduced by the patient recollecting the events. Additionally, by learning to recognize mental health events outside of therapy and either making the person aware of these or offering an appropriate intervention or coaching at the right time, the user's mental health can be improved.

Sensors may include any number or combination of worn or accessible cameras, physiological and activity sensors (e.g., heart rate monitors, pulse monitors, oxygen sensors, glucose meters), sensors embedded in clothing or worn on the user (watch, strap, earrings, and the like), sensors in nearby devices and furniture, Internet of Things devices, and the like. Data collected may include sensor data such as audio, video, location (e.g., from a Global Positioning System), identifying persons the user is with, what activity the user is engaged in, physiological data, as well as data from other sources, such as applications on the user's mobile or other computing devices (e.g., the user's calendar, email, text messages, and the like). The data may be encrypted and privacy protected. The sensor data may be generalized for example, by converting the actual heart rates of the user to descriptors such as “raised heart rate.” Sound waves received may be converted to an identification of the source of the sound, such as “dog barking heard.” Video may be converted to an identification what is shown: “anxiety detected on face.” This “in the moment” data captured could be additionally analyzed in the context of longer term information such as sleep patterns, general physical activity (number of hours sedentary, amount of exercise, change of exercise habits), semantic location, time at location, people you are with (if identifiable), the time of day, day of week, preceding activity, and any other anomalies.

As noted this data may be collected, and labeled by the person as representative of a mental health event occurred, for example, where emotion “x” had occurred. The system may collect the sensor data, time stamp the incident and add any additional comments the person chose to include with the label. The capture may include all data immediately relevant to the situation: audio, video, location, who you were with, what were you trying to do (soft-sensing), physiological variables for a certain window of time, and the like. This rich data may then be later reviewed against the context at the time of the incident, other longer term context information, captured by wearable or system of wearables that the person was using, such as sleep patterns, general physical activity (number of hours sedentary, amount of exercise, change of exercise habits), semantic location, time at location, people you are with (if identifiable), the time of day, day of week, preceding activity, and any other anomalies.

The system may also incorporate data from other people—if available and following privacy policies set up by the user—if such policies allow for this data to be shared, even in anonymous format. This crowd-sourced collection of contextual data can be done on-demand if a particular situation requires multiple data to be analyzed. For example, measuring the emotional response of the subject may not be sufficient—and the response of other people who may be involved in an incident may prove useful.

In some examples, the system may also automatically make causal associations between the mental health event and patterns of sensor readings, for example, by utilizing machine learning algorithms. As an example of the situations this system may be useful, a user may be embarrassed that they are afraid of a certain stimuli, for example, a neighbor's dog. Subconsciously this person may not want to admit or recognize this fear because of this embarrassment. The system may uncover this by automatically determining that a dog barking was correlated with certain physiological sensor readings that are correlated with a fear response. Once a pattern such as this was identified, the system may mine past data to identify, for example, other instances of dogs barking. Additionally, going forward, when the system detects a trigger such as a dog barking, the system may proactively act. This action may include making the person cognitively aware of the situation, e.g. inquiring “Does this dog make you nervous?” or may trigger any number of personalized emotional regulation interventions. In some examples, this may also include dispensing or administering anxiety reducing medication.

As noted, the user may input to the system that a mental health event has occurred either to annotate the sensor logs themselves, and/or for training the system to automatically recognize the mental health event. This could be any assigned device input, such as a physical or virtual button, an input into a touch screen, a physical gesture (which may be detected by an accelerometer), a voice or other sound-based input, or the like. These inputs may be detected by the computing device of the user and/or one or more of the sensors in the system. In a subsequent therapy session the user and the therapist may review the tagged instances together and discuss the best way to describe the experiences for the algorithm. A machine learning algorithm may take the person's own labels and/or the jointly revised labels and the corresponding sensor data as training data captured in the specified time period and use this to develop methods for automatically identifying similar moments.

The apparatus could additionally store, analyze and derive sensor data for as many of a person's life events as was desired. Once a pattern was identified or if a pattern was hypothesized, the person or therapist may utilize the system to find similar patterns. For example, if a particular person seemed to be a trigger, the data could be queried to see if interactions with that person always or often generated the same reaction or if there was a point in time where the relationship seemed to have changed. This discovery could then lead to a new talking point or examination point in the therapy. Additionally, if a person seemed to be more stressed for example, before a flight, the past data could be queried to see if this had always been the case (querying times before all known flights) or if there was some period of time before which that had not been the case.

As noted, a pattern or trigger can be identified automatically by the system or manually by an expert therapist after manually reviewing the data and talking to the patient. In both cases, these patterns are stored in the system and compared in real time going forward with newly identified incidents and/or raw data in order to identify, predict similar cases and respond in real time if possible with an appropriate action.

Additionally once, a pattern had been identified: e.g. a positive or negative pattern with a particular person, for example, a fear of dogs or flying, the proximity of a bar for alcohol craving; the system could proactively suggest an intervention or use the knowledge of this trigger in a recommender system. For example if the user is afraid of dogs, when planning a trip to the beach the system could recommend a beach nearby that doesn't allow dogs. In examples in which certain people cause undesirable mental health stresses, the system could recommend either avoiding or seeking out certain people or implementing encounter strategies if meetings with these people were planned (e.g. “remember date night tonight—look forward to it!” or “this person bugs you remember to keep your conversations on topic and short”).

The system may also be used to augment interactions between different people, for example as a tool for couples therapy or family therapy. This may allow augmented insight into different perspectives of a situation, for example were both members of the couple equally affected by an incident? What was the relative severity? What preceding events potentiated the incident? Additionally, when used in family therapy with children insights regarding how adult behavior: yelling, absence, reward, time together etc. impacted the child's experiences.

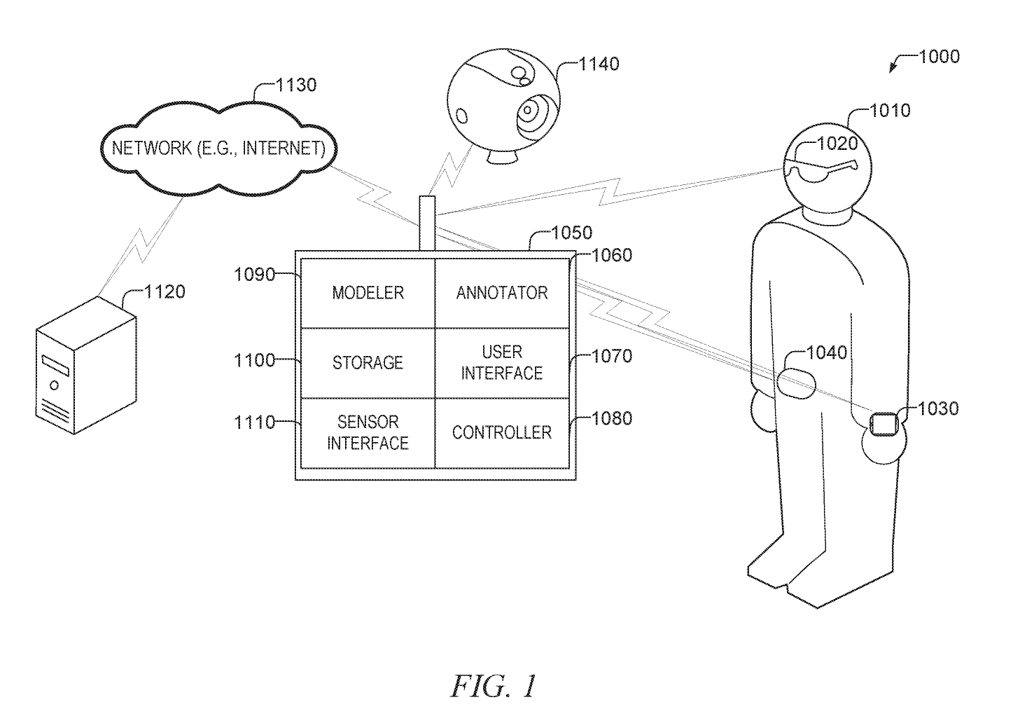

Turning now to FIG. 1, a diagram of a mental health system 1000 is shown according to some examples of the present disclosure. User 1010 has a number of devices proximate the user, such as smart glasses 1020, smart watch 1030, glucose meter 1040, and the like. These devices 1020, 1030, and 1040 may have a variety of onboard or linked sensors such as a video camera, audio recording device, pulse sensor, heart rate sensor, glucose sensor, oxygen sensor, light sensor, Global Positioning System (GPS) receiver, accelerometer, g-force sensor, and the like. User 1010 may also be in proximity to a mobile device 1050, for example, a smartphone which may also have one or more sensors. Mobile device 1050 may have one or more modules or components, such as annotator 1060, user it interface 1070, controller 1080, modeler 1090, storage 1100, and sensor interface 1110.

The sensor interface 1110 may communicate with one or more sensors integrated in the mobile device as well as communicating with other devices, such as smart glasses 1020, smart watch 1030, glucose meter 1040, and the like to subscribe, request, receive, or otherwise obtain sensor data from sensors on these devices. This sensor data may be streamed from these sensors in real-time or near real time. Controller 1080 may receive the streamed sensor data and correlate it to one or more discrete time periods (e.g., group sensor data into chunks of contiguous time). The sensor data for the time periods may be cached and may be submitted to the modeler 1090.

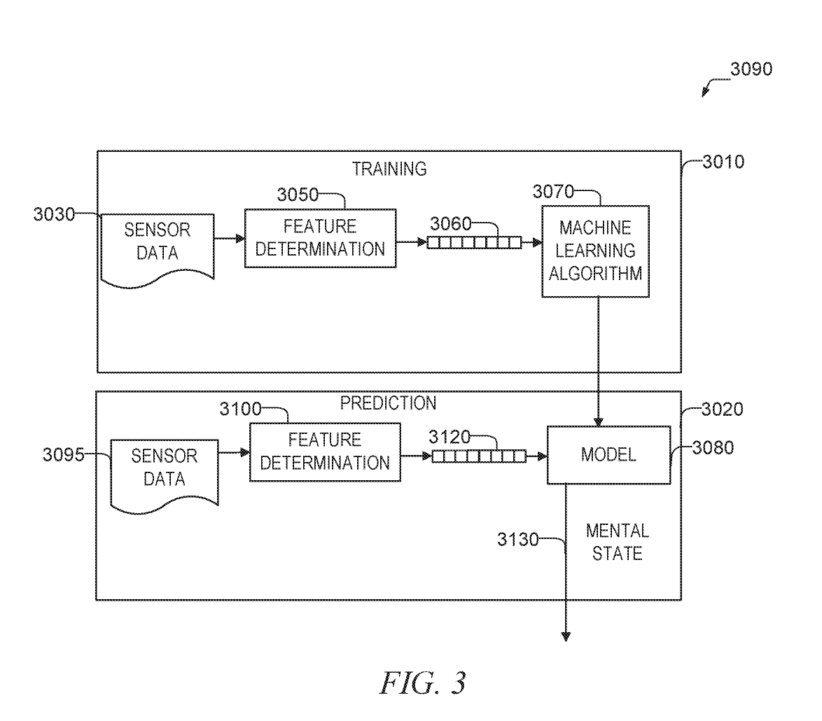

Modeler 1090 may utilize a trained machine learning model (e.g., as demonstrated in FIG. 3) to determine based upon current sensor data whether the data is indicative of a mental health event. In other examples, the user 1010 may utilize one or more user interfaces provided by user interface 1070 to manually indicate that a mental health event is occurring (which in some examples may be utilized to train the model). In some examples, upon determining that a mental health event is occurring, the controller 1080 may instruct storage 1100 to store a more complete or higher fidelity version of the data. Annotator 1060 may allow the user 1010, in conjunction with the user interface 1070 to provide annotations on the mental health event, such as how the user 1010 feels, what the user 1010 feels caused the event, and the like. Annotations may also include an indication of the mental health event predicted by the modeler 1090 based upon the data. Storage 1100 may store sensor data and annotations. This storage may be locally on the mobile device 1050 or remotely on a storage server 1120 over a network 1130. In some examples, the mobile device 1050 may also collect data from external sensors, such as a camera 1140.

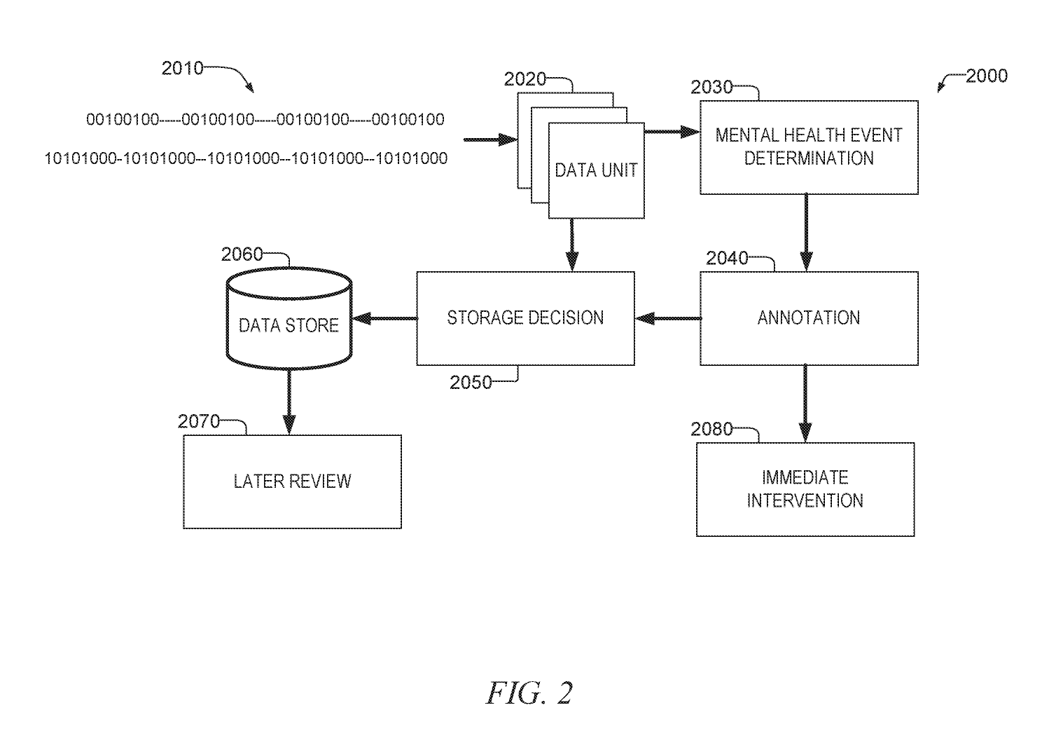

Turning now to FIG. 2, a flow diagram 2000 of the operation of the mental health system is shown according to some examples of the present disclosure. Data streams 2010 from the sensors are packaged into data units 2020 representing time ranges for the sensor data. This data 2020 may then be used to make a mental health event determination 2030 as to whether the user is having a configured mental health event. For example, the data 2020 may be submitted to a modeler 1090, or the user may indicate through a user interface that they are having a mental health event.

Regardless of whether a mental health event is detected or determined, the user may annotate 2040 the data with their feelings and their impressions of the events. Annotation 2040 includes tagging the data with any detected or determined mental health events 2030. Based upon these annotations and determinations, the system decides 2050 on whether and how much data to store in data storage 2060. As noted, the system may store more data if a mental health event is ongoing than it would if no mental health event is detected or indicated. In some examples, the data is compressed, encrypted, or otherwise protected.

At 2070, the system may recall stored data for later review. For example, at a mental health professional's office during therapy. At 2080, if a mental health event is detected, a determination may be made as to whether or not to offer intervention. This determination may be setup based upon a rule set. That is, the offered intervention is specified (e.g., programmed into the device by the user or mental health professional) and may depend on the type of mental health event and the likely cause (as determined by the system).

FIG. 3 shows an example modeler 3090 according to some examples of the present disclosure. Modeler 3090 may be an instance of modeler 1090. Modeler 3090 implements a machine learning algorithm utilizing a training module 3010 and a prediction module 3020. Training module 3010 feeds historical sensor data 3030 that has been labelled with mental health events into feature determination module 3050. Feature determination module 3050 determines one or more features 3060 from this information. Features 3060 are a subset of the information input and is information determined to be predictive of a mental health event. In some examples, the features may be all the sensor data 3030 or a subset of the sensor data 3030. Feature data may be selected by an administrator of the system, or may be selected based upon one or more heuristic rules. In some examples, some sensor data 3030 may be combined or transformed according to one or more rules. For example, sensor data may be compared with patterns to reach a hypothesis about the data (e.g., the user's heartrate is elevated, the user is sleeping, and the like). The hypothesis may then be used as input to the machine learning algorithm 3070 rather than the data itself.

The machine learning algorithm 3070 produces a model 3080 based upon the features and feedback associated with those features. For example, the model 3080 may be a classifier that is used to classify the user's emotional responses into one or more categories of mental states. The user and/or health professional may classify one or more of these mental states as a mental health event. The training may be based upon a learning period in which the user provides explicit feedback on when they are having a mental health event (either at the time it happens, or later).

In some examples, the score model 3080 may be utilized for multiple persons (e.g., built of training data accumulated for all users of all systems, regardless of which user's submitted the data), or may be built specific for each user. Moreover, the model 3080 may be initially built with global user data, but then the model may be refined using feedback for a particular user such that it starts out with a good guess on the emotional states of the user, but then customizes itself to the actual user's emotions.

In the prediction module 3020, the current sensor data 3095 may be input to the feature determination module 3100. Feature determination module 3100 may determine the same set of features or a different set of features as feature determination module 3050. In some examples, feature determination module 3100 and 3050 are the same module. Feature determination module 3100 produces features 3120, which are input into the model 3080 to generate a user's mental state 3130. Mental states may include: happy, sad, fearful, angry, depressed, embarrassed, scared, and the like. As noted, the user or a mental health professional may determine (e.g., tag) one or more of these mental states as mental health events that then trigger data tagging and/or increased data saving. These tags may then be utilized to update the model 3080. The training module 3010 may operate in an offline manner to train the model 3080. The prediction module 3020, however, may be designed to operate in an online manner as data is collected.

It should be noted that the model 3080 may be periodically updated via additional training and/or user feedback. The user feedback may be either feedback from users giving explicit feedback. This feedback may be provided from a mental health professional, the patient (e.g., the user), a trusted friend or companion, or other authorized user.

The machine learning algorithm 3070 may be selected from among many different potential supervised or unsupervised machine learning algorithms. Examples of supervised learning algorithms include artificial neural networks (including multiclass neural networks), Bayesian networks, instance-based learning, support vector machines, decision trees (e.g., Iterative Dichotomiser 3, C4.5, Classification and Regression Tree (CART), Chi-squared Automatic Interaction Detector (CHAD), and the like),random forests, linear classifiers, quadratic classifiers, k-nearest neighbor, linear regression, logistic regression (including multiclass logistic regression), decision forests (including multiclass decision forests), and hidden Markov models. Examples of unsupervised learning algorithms include expectation-maximization algorithms, vector quantization, and information bottleneck method. In an example embodiment, a multiclass logistic regression model is used.

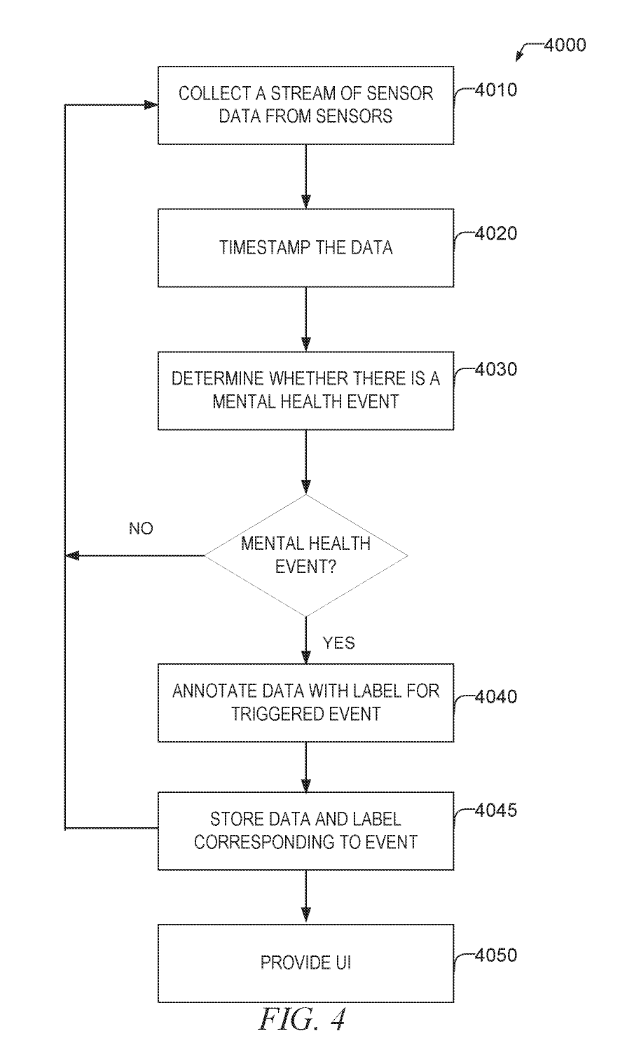

Turning now to FIG. 4, a flowchart of a method 4000 of determining mental health events is shown according to some examples of the present disclosure. At operation 4010 the system collects a stream of sensor data from a set of two or more sensors. The sensor data may correspond to measurements or other data about a user of the system or their environment. At operation 4020 the system may group the data into one or more data units and timestamp the data. At operation 4030, the system may determine whether there is a mental health event. As already noted, this may be done on the basis of an analysis of the data by one or more algorithms such as matching a physiological sensor with a known pattern that indicates the mental health event, inputting the data to a machine learning algorithm, manually identifying the event, or the like).

If there is a mental health event, then at operation 4040 the data may be automatically annotated with a label describing the mental health event. Additionally, the user may be prompted for additional thoughts and feelings. In some examples, even in the absence of a mental health event the user may annotate the data based upon their feelings and experiences. This annotation may include text input (e.g., a keyboard, touchscreen, and the like), voice input, motion input (e.g., certain gestures that select preselected annotations), and the like.

At operation 4045, the sensor data in the stream that is within a predetermined temporal proximity to the occurrence of the mental health event may be stored. As noted previously, how much data is stored and whether data is stored only upon the occurrence of a detection of a mental health event may be vary. For example, all data may be stored all the time and the system may make automatic annotations upon detecting a mental health event. In other examples, the system may store a first subset of sensor data in the stream of sensor data collected temporally proximate to the mental health event and store a second subset of sensor data in the stream of sensor data collected that is not temporally proximate to mental health event (e.g., all other data), wherein the first subset is larger than the second subset. In still other examples, only data that is temporally proximate to the mental health event is stored. In some examples, how much data to store and when to store it may be configurable by the user. In yet other examples, how much data and when to store it may be changed automatically by the system depending on how much non-volatile storage is left for storing the data. For example, the system may start out by storing all data all the time. Then, when a configured percentage of disk space is utilized, then the system may switch to storing a smaller subset of all data normally, but then storing the full set of data for data temporally proximate a mental health event, A further threshold may be reached as the non-volatile storage fills up that, when transgressed, only stores data temporally proximate a mental health event.

Once the annotations are complete and the data stored, the system may continue collecting and analyzing data at operation 4010. In some examples, the system may provide a user interface, such as a Graphical User Interface (GUI) at operation 4050. The UI may provide intervention—e.g., based upon a detection of a mental health event and an analysis of a likely cause. The intervention may be programmed into the system, by, for example, a series of if-then rules. For example, if the user is anxious and a dog bark is detected, suggest that the user breathe deeply. The intervention may be a message, a haptic queue, a video, an audio file, an automatic call (or a suggestion to call) a therapist, and the like. Example interventions may also include avoidance suggestions e.g., if the user gets angry over bad traffic, the system may determine the current traffic and the user's route and then provide alternative routes or suggest either leaving early or later. In other examples, the UI at operation 4050 is a UI for viewing data and annotations, e.g., for use in a subsequent therapy session.

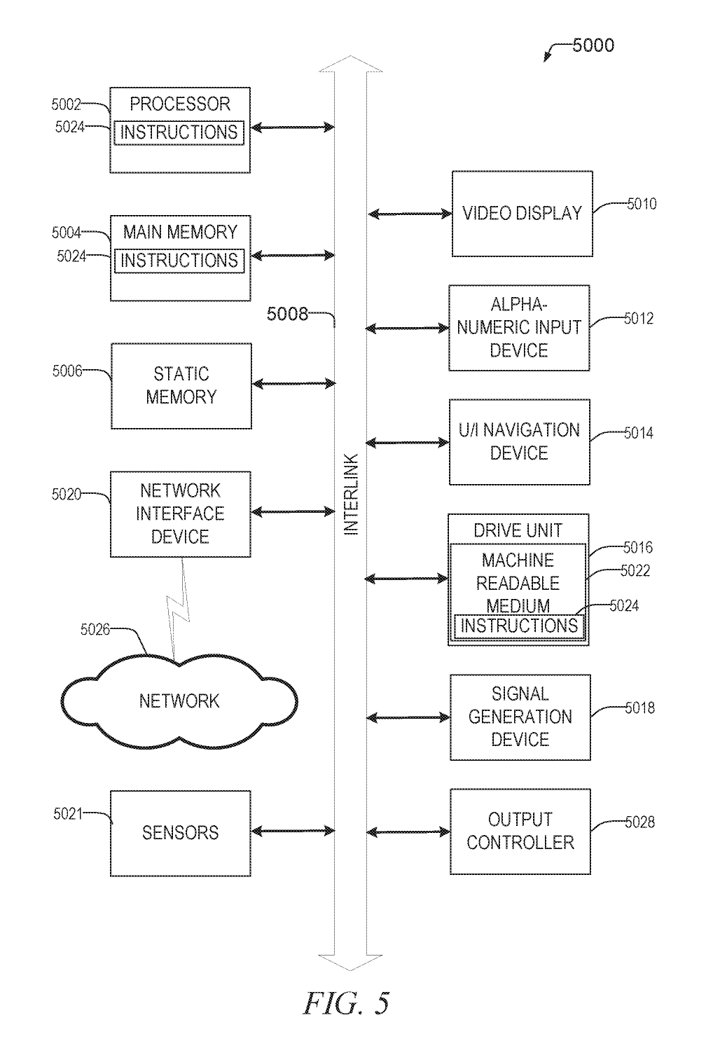

FIG. 5 illustrates a block diagram of an example machine 5000 upon which any one or more of the techniques (e.g., methodologies) discussed herein may perform. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. For example, machine 5000 may implement the mobile device 1050 and implement FIGS. 2-4. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802,16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques,

### OTHER NOTES AND EXAMPLES

Example 1 is a system for determining mental health events, the system comprising: at least one processor; and at least one machine readable medium comprising instructions, which when executed by the at least one processor, cause the processor to perform operations comprising: collecting a stream of sensor data from a set of two or more sensors; determining an occurrence of a mental health event in the sensor data based upon a determination that at least one physiological sensor reacting indicates a predetermined triggering value; in response to the determination that the mental health event occurred: automatically annotating a stored representation of the stream of sensor data with a label indicating the mental health event; storing sensor data in the stream of sensor data that is within a predetermined temporal proximity to the occurrence of the mental health event; and providing a graphical user interface (GUI) which presents the stored representation of the stream of sensor data and the corresponding label.

In Example 2, the subject matter of Example 1 optionally includes wherein the operations of determining the occurrence of the mental health event comprises operations of receiving input from the user indicating the presence of the mental health event.

In Example 3, the subject matter of any one or more of Examples 1-2 optionally include wherein the operations of determining the occurrence of the mental health event comprises operations of inputting the sensor stream into a machine learning algorithm, wherein the machine learning algorithm indicates a mental health event.

In Example 4, the subject matter of Example 3 optionally includes wherein the machine learning algorithm is trained based upon past streams of sensor data labeled based upon the mental health event.

In Example 5, the subject matter of any one or more of Examples 1-4 optionally include wherein the operations further comprise: responsive to determining the occurrence of the mental health event, providing an intervention, the intervention comprising a mental health suggestion to the user.

In Example 6, the subject matter of any one or more of Examples 1-5 optionally include wherein the operations further comprise: responsive to determining the occurrence of the mental health event, automatically calling a stored phone number of a mental health professional,

In Example 7, the subject matter of any one or more of Examples 1-6 optionally include wherein a sensor of the set of two or more sensors comprises one of: a heart-rate sensor, a camera, a microphone, a global positioning system (GPS), an accelerometer, a pulse measuring device, or an oxygen sensor.

In Example 8, the subject matter of any one or more of Examples 1-7 optionally include wherein the operations further comprise: storing the entire stream of sensor data.

In Example 9, the subject matter of any one or more of Examples 1-8 optionally include wherein the operations further comprise: storing the stream of sensor data collected that is temporally proximate to the triggering event.

In Example 10, the subject matter of any one or more of Examples 1-9 optionally include wherein the operations further comprise: storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.

In Example 11, the subject matter of any one or more of Examples 1-10 optionally include wherein the operations further comprise: storing extracted features from the stream of sensor data.

In Example 12, the subject matter of any one or more of Examples 1-11 optionally include wherein the operations further comprise anonymising at least one item of data in the stream of sensor data.

In Example 13, the subject matter of any one or more of Examples 1-12 optionally include a storage device; a sensor of the two or more sensors; and wherein the operations of storing sensor data in the stream of sensor data comprises storing the sensor data in the storage device.

Example 14 is a method for determining mental health events, the method comprising: collecting a stream of sensor data from a set of two or more sensors; determining an occurrence of a mental health event in the sensor data based upon a determination that at least one physiological sensor reading indicates a predetermined triggering value; in response to the determination that the mental health event occurred: automatically annotating a stored representation of the stream of sensor data with a label indicating the mental health event; storing sensor data in the stream of sensor data that is within a predetermined temporal proximity to the occurrence of the mental health event; and providing a graphical user interface (GUI) which presents the stored representation of the stream of sensor data and the corresponding label.

In Example 15, the subject matter of Example 14 optionally includes wherein determining the occurrence of the mental health event comprises receiving input from the user indicating the presence of the mental health event.

In Example 16, the subject matter of any one or more of Examples 14-15 optionally include wherein determining the occurrence of the mental health event comprises inputting the sensor stream into a machine learning algorithm, wherein the machine learning algorithm indicates a mental health event.

In Example 17, the subject matter of Example 16 optionally includes wherein the machine learning algorithm is trained based upon past streams of sensor data labeled based upon the mental health event.

In Example 18, the subject matter of any one or more of Examples 14-17 optionally include responsive to determining the occurrence of the mental health event, providing an intervention, the intervention comprising a mental health suggestion to the user.

In Example 19, the subject matter of any one or more of Examples 14-18 optionally include responsive to determining the occurrence of the mental health event, automatically calling a stored phone number of a mental health professional.

In Example 20, the subject matter of any one or more of Examples 14-19 optionally include wherein a sensor of the set of two or more sensors comprises one of: a heart-rate sensor, a camera, a microphone, a global positioning system (GPS), an accelerometer, a pulse measuring device, or an oxygen sensor.

In Example 21, the subject matter of any one or more of Examples 14-20 optionally include storing the entire stream of sensor data.

In Example 22, the subject matter of any one or more of Examples 14-21 optionally include storing the stream of sensor data collected that is temporally proximate to the triggering event.

In Example 23, the subject matter of any one or more of Examples 14-22 optionally include storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.

In Example 24, the subject matter of any one or more of Examples 14-23 optionally include storing extracted features from the stream of sensor data.

In Example 25, the subject matter of any one or more of Examples 14-24 optionally include anonymizing at least one item of data in the stream of sensor data.

Example 26 is at least one non-transitory machine-readable medium, comprising instructions for determining mental health events, the instructions, when executed by the machine, cause the machine to perform operations comprising: collecting a stream of sensor data from a set of two or more sensors; determining an occurrence of a mental health event in the sensor data based upon a determination that at least one physiological sensor reading indicates a predetermined triggering value; in response to the determination that the mental health event occurred: automatically annotating a stored representation of the stream of sensor data with a label indicating the mental health event; storing sensor data in the stream of sensor data that is within a predetermined temporal proximity to the occurrence of the mental health event; and providing a graphical user interface (GUI) which presents the stored representation of the stream of sensor data and the corresponding label.

In Example 27, the subject matter of Example 26 optionally includes wherein the operations of determining the occurrence of the mental health event comprises operations of receiving input from the user indicating the presence of the mental health event.

In Example 28, the subject matter of any one or more of Examples 26-27 optionally include wherein the operations of determining the occurrence of the mental health event comprises operations of inputting the sensor stream into a machine learning algorithm, wherein the machine learning algorithm indicates a mental health event.

In Example 29, the subject matter of Example 28 optionally includes wherein the machine learning algorithm is trained based upon past streams of sensor data labeled based upon the mental health event.

In Example 30, the subject matter of any one or more of Examples 26-29 optionally include wherein the operations further comprise: responsive to determining the occurrence of the mental health event, providing an intervention, the intervention comprising a mental health suggestion to the user.

In Example 31, the subject matter of any one or more of Examples 26-30 optionally include wherein the operations further comprise: responsive to determining the occurrence of the mental health event, automatically calling a stored phone number of a mental health professional.

In Example 32, the subject matter of any one or more of Examples 26-31 optionally include wherein a sensor of the set of two or more sensors comprises one of: a heart-rate sensor, a camera, a microphone, a global positioning system (GPS), an accelerometer, a pulse measuring device, or an oxygen sensor.

In Example 33, the subject matter of any one or more of Examples 26-32 optionally include wherein the operations further comprise: storing the entire stream of sensor data.

In Example 34, the subject matter of any one or more of Examples 26-33 optionally include wherein the operations further comprise: storing the stream of sensor data collected that is temporally proximate to the triggering event.

In Example 35, the subject matter of any one or more of Examples 26-34 optionally include wherein the operations further comprise: storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.

In Example 36, the subject matter of any one or more of Examples 26-35 optionally include wherein the operations further comprise: storing extracted features from the stream of sensor data.

In Example 37, the subject matter of any one or more of Examples 26-36 optionally include wherein the operations further comprise anonymizing at least one item of data in the stream of sensor data.

Example 38 is a device for determining mental health events, the device comprising: means for collecting a stream of sensor data from a set of two or more sensors; means for determining an occurrence of a mental health event in the sensor data based upon a determination that at least one physiological sensor reading indicates a predetermined triggering value; in response to the determination that the mental health event occurred: means for automatically annotating a stored representation of the stream of sensor data with a label indicating the mental health event; means for storing sensor data in the stream of sensor data that is within a predetermined temporal proximity to the occurrence of the mental health event; and means for providing a graphical user interface (GUI) which presents the stored representation of the stream of sensor data and the corresponding label.

In Example 39, the subject matter of Example 38 optionally includes wherein the means for determining the occurrence of the mental health event comprises means for receiving input from the user indicating the presence of the mental health event.

In Example 40, the subject matter of any one or more of Examples 38-39 optionally include wherein the means for determining the occurrence of the mental health event comprises means for inputting the sensor stream into a machine learning algorithm, wherein the machine learning algorithm indicates a mental health event.

In Example 41, the subject matter of Example 40 optionally includes wherein the machine learning algorithm is trained based upon past streams of sensor data labeled based upon t mental health event.

In Example 42, the subject matter of any one or more of Examples 38-41 optionally include responsive to determining the occurrence of the mental health event, means for providing an intervention, the intervention comprising a mental health suggestion to the user.

In Example 43, the subject matter of any one or more of Examples 38-42 optionally include responsive to determining the occurrence of the mental health event, means for automatically calling a stored phone number of a mental health professional.

In Example 44, the subject matter of any one or more of Examples 38-43 optionally include wherein a sensor of the set of two or more sensors comprises one of: a heart-rate sensor, a camera, a microphone, a global positioning system (GPS), an accelerometer, a pulse measuring device, or an oxygen sensor,

In Example 45, the subject matter of any one or more of Examples 38-44 optionally include means for storing the entire stream of sensor data.

In Example 46, the subject matter of any one or more of Examples 38-45 optionally include means for storing the stream of sensor data collected that is temporally proximate to the triggering event.

In Example 47, the subject matter of any one or more of Examples 38-46 optionally include means for storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.

In Example 48, the subject matter of any one or more of Examples 38-47 optionally include means for storing extracted features from the stream of sensor data.

In Example 49, the subject matter of any one or more of Examples 38-48 optionally include means for anonymizing at least one item of data in the stream of sensor data.

What is claimed is:

1. A system for determining mental health events, the system comprising:
at least one processor; and
at least one machine readable medium comprising instructions, which when executed by the at least one processor, cause the processor to perform operations comprising:
collecting a stream of sensor data from a set of two or more sensors;
determining an occurrence of a mental health event in the sensor data based upon a determination that at least one physiological sensor reading indicates a predetermined triggering value;
in response to the determination that the mental health event occurred:
automatically annotating a stored representation of the stream of sensor data with a label indicating the mental health event;
storing sensor data in the stream of sensor data that is within a predetermined temporal proximity to the occurrence of the mental health event; and
providing a graphical user interface (GUI) which presents the stored representation of the stream of sensor data and the corresponding label.

2. The system of claim 1, wherein the operations of determining the occurrence of the mental health event comprises operations of receiving input from the user indicating the presence of the mental health event.

3. The system of claim 1, wherein the operations of determining the occurrence of the mental health event comprises operations of inputting the sensor stream into a machine learning algorithm, wherein the machine learning algorithm indicates a mental health event.

4. The system of claim 3, wherein the machine learning algorithm is trained based upon past streams of sensor data labeled based upon the mental health event.

5. The system of claim 1, wherein the operations further comprise: responsive to determining the occurrence of the mental health event, providing an intervention, the intervention comprising a mental health suggestion to the user.

6. The system of claim 1, wherein the operations further comprise: responsive to determining the occurrence of the mental health event, automatically calling a stored phone number of a mental health professional.

7. The system of claim 1, wherein a sensor of the set of two or more sensors comprises one of:
a heart-rate sensor, a camera, a microphone, a global positioning system (GPS), an accelerometer, a pulse measuring device, or an oxygen sensor.

8. The system of claim 1, wherein the operations further comprise:
storing the entire stream of sensor data.

9. The system of claim 1, wherein the operations further comprise:
storing the stream of sensor data collected that is temporally proximate t the triggering event.

10. The system of claim 1, wherein the operations further comprise:
storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.

11. The system of claim 1, wherein the operations further comprise:
storing extracted features from the stream of sensor data.

12. The system of claim 1 further comprising:
a storage device;
a sensor of the two or more sensors;
and wherein the operations of storing sensor data in the stream of sensor data comprises storing the sensor data in the storage device.

13. A method for determining mental health events, the method comprising:
collecting a stream of sensor data from a set of two or more sensors;
determining an occurrence of a mental health event in the sensor data based upon a determination that at least one physiological sensor reading indicates a predetermined triggering value;
in response to the determination that the mental health event occurred:
automatically annotating a stored representation of the stream of sensor data with a label indicating the mental health event;
storing sensor data in the stream of sensor data that is within a predetermined temporal proximity to the occurrence of the mental health event; and
providing a graphical user interface (GUI) which presents the stored representation of the stream of sensor data and the corresponding label.

14. The method of claim 13, wherein determining the occurrence of the mental health event comprises receiving input from the user indicating the presence of the mental health event.

15. The method of claim 13, wherein determining the occurrence of the mental health event comprises inputting the sensor stream into a machine learning algorithm, wherein the machine learning algorithm indicates a mental health event.

16. At least one non-transitory machine-readable medium, comprising instructions for determining mental health events, the instructions, when executed by the machine, cause the machine to perform operations comprising:
collecting a stream of sensor data from a set of two or more sensors;
determining an occurrence of a mental health event in the sensor data based upon a determination that at least one physiological sensor reading indicates a predetermined triggering value;
in response to the determination that the mental health event occurred:
automatically annotating a stored representation of the stream of sensor data with a label indicating the mental health event;
storing sensor data in the stream of sensor data that is within a predetermined temporal proximity to the occurrence of the mental health event; and
providing a graphical user interface (GUI) which presents the stored representation of the stream of sensor data and the corresponding label.

17. The at least one machine-readable medium of claim 16, wherein the operations of determining the occurrence of the mental health event comprises operations of receiving input from the user indicating the presence of the mental health event.

18. The at least one machine-readable medium of claim 16, wherein the operations of determining the occurrence of the mental health event comprises operations of inputting the sensor stream into a machine learning algorithm, wherein the machine learning algorithm indicates a mental health event.

19. The at least one machine-readable medium of claim 18, wherein the machine learning algorithm is trained based upon past streams of sensor data labeled based upon the mental health event.

20. The at least one machine-readable medium of claim 16, wherein the operations further comprise: responsive to determining the occurrence of the mental health event, providing an intervention, the intervention comprising a mental health suggestion to the user.

21. The at least one machine-readable medium of claim 16, wherein the operations further comprise: responsive to determining the occurrence of the mental health event, automatically calling a stored phone number of a mental health professional.

22. The at least one machine-readable medium of claim 16, wherein a sensor of the set of two or more sensors comprises one of: a heart-rate sensor, a camera, a microphone, a global positioning system (GPS), an accelerometer, a pulse measuring device, or an oxygen sensor.

23. The at least one machine-readable medium of claim 16, wherein the operations further comprise:
storing the entire stream of sensor data.

24. The at least one machine-readable medium of claim 16, wherein the operations further comprise:
storing the stream of sensor data collected that is temporally proximate to the triggering event.

25. The at least one machine-readable medium of claim 16, wherein the operations further comprise:
storing a first subset of sensor data in the stream of sensor data collected that is temporally proximate to the mental health event and storing a second subset of sensor data in the stream of sensor data collected that is not temporally proximate to the mental health event, wherein the first subset is larger than the second subset.
